(19) United States
(12) Patent Application Publication
(10) Pub. No.: US 2018/0303089 A1
(43) Pub. Date: Oct. 25, 2018

(54) COMPOSITIONS AND METHODS FOR PROTECTING PLANTS FROM ORGANISMS

(71) Applicant: Imerys Filtration Minerals, Inc., San Jose, CA (US)

(72) Inventors: David GITTINS, San Jose, CA (US); James O'NEIL, Hermosa Beach, CA (US)

(21) Appl. No.: 15/767,493

(22) PCT Filed: Oct. 12, 2016
(86) PCT No.: PCT/US16/56537

§ 371 Date: Apr. 11, 2018

Related U.S. Application Data
(60) Provisional application No. 62/240,721, filed on Oct. 13, 2015.
(60) Provisional application No. 62/355,312, filed on Jun. 27, 2016.

(51) Int. Cl. A01N 25/22; A01N 31/16; A01N 43/22

(52) U.S. Cl. CPC A01N 25/22; A01N 25/04; A01N 43/22; A01N 31/16

(57) ABSTRACT

A method for protecting a plant from an arthropod may include applying an amount of a repellant composition including diatomaceous earth to a plant. According to some aspects, the repellent composition may render the plant unpalatable to the arthropod, resulting in death of the arthropod by starvation. A method for protecting a plant from an arthropod may include applying an amount of a repellant composition including diatomaceous earth to a plant. The arthropod may not include an exoskeleton, and the repellent composition may render the plant unpalatable to the arthropod, resulting in death of the arthropod by starvation.

### CLAIM FOR PRIORITY

This PCT International Application claims the benefit of priority of U.S. Provisional Patent Application Nos. 62/240,721, filed Oct. 13, 2015 and 62/355,312, filed Jun. 27, 2016, the subject matter of which is incorporated herein by reference in its entirety.

### FIELD OF THE DISCLOSURE

The present disclosure relates to compositions and methods for protecting plants from organisms, and more particularly, to compositions and methods including diatomaceous earth for protecting plants from organisms.

### BACKGROUND

Insecticides have been used to protect plants from organisms such as undesirable insects. The effectiveness of insecticides often relies on the ability of the insecticide to kill the undesirable insects. However, many insecticides suffer from a number of undesirable characteristics. For example, many insecticides include chemical compositions that are harmful to the environment and humans as well as to the insects. Thus, it is desirable to develop alternative compositions and/or methods to protect plants from organisms while mitigating or eliminating undesirable effects to the environment and humans.

Certain forms of diatomaceous earth have been used to kill insects associated with being harmful to plants. It is believed that such forms of diatomaceous earth are effective at killing some insects as a result of direct, physical contact between the insects and the diatomaceous earth. For example, it is believed that when some hard-bodied insects having exoskeletons contact sharp edges of diatomaceous earth particles, the diatomaceous earth particles damage the exoskeleton of the insect by scraping and scratching it. As a result, the insects slowly die due to loss of fluids from the exoskeleton.

However, this method of killing the organisms may suffer from a number of possible drawbacks. For example, it may be difficult to apply the diatomaceous earth to plants in a manner sufficient to prevent substantial damage to the plants before the insects are killed. In some instances, it may be difficult to cover certain areas of the plant foliage, and thus, the organisms may thrive and multiply in such areas, and once the effectiveness of the insecticide has subsided due, for example, to dilution from water resulting from rain or irrigation, the organisms may multiply and significantly damage the plants.

In addition, the method described above with respect to diatomaceous earth may not be effective against certain organism species or may not be effective for protecting certain plant species. For example, soft-bodied organisms, such as, for example, caterpillars of various species, are incredibly destructive to crops and are resistant to the above-noted method using diatomaceous earth because they do not have exoskeletons. Thus, the mechanism of the above-noted method often proves ineffective against such soft-bodied organisms and may fail to adequately protect plant species susceptible to damage from soft-bodied organisms.

Thus, it may be desirable to develop new methods for protecting plants that do not necessarily suffer from the above-noted possible drawbacks with prior art compositions and methods. The compositions and methods disclosed herein may mitigate or eliminate one or more of such drawbacks.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

According to a first aspect, a method for protecting a plant from an arthropod may include applying an amount of a repellant composition including diatomaceous earth to a plant. According to some aspects, the repellent composition may render the plant unpalatable to the arthropod, resulting in death of the arthropod by starvation.

According to a further aspect, a method for protecting a plant from an arthropod may include applying an amount of a repellant composition including diatomaceous earth to a plant. The arthropod may not include an exoskeleton, and the repellent composition may render the plant unpalatable to the arthropod, resulting in death of the arthropod by starvation.

Exemplary objects and advantages will be set forth in part in the description which follows, or may be learned by practice of the exemplary embodiments. It is to be understood that both the foregoing general description and the following detailed description are exemplary and explanatory only and are not restrictive of the invention, as claimed.

### BRIEF DESCRIPTION OF DRAWINGS

FIG. 1 is graphical representation of average count of first instar corn earworm larvae on the chickpea at four rating intervals.

FIG. 2 is a graphical representation of first instar corn earworm larvae control using Henderson-Tilton.

FIG. 3 is a graphical representation of average count of second instar larvae corn earworm on the chickpea at four rating intervals.

FIG. 4 is a graphical representation of second instar corn earworm larvae control using Henderson-Tilton.

FIG. 5 is a graphical representation of average count of third instar larvae corn earworms on the chickpea at four rating intervals.

FIG. 6 is a graphical representation of third instar corn earworm larvae control using Henderson-Tilton.

FIG. 7 is a graphical representation of average count of fourth instar larvae corn earworms on the chickpea at four rating intervals.

FIG. 8 is a graphical representation of fourth instar corn earworm larvae control using Henderson-Tilton.

FIG. 9 is a graphical representation showing average count of all instars of corn earworm larvae on chickpeas at four rating intervals.

FIG. 10 is a graphical representation of all instars of corn earworm larvae control using Henderson-Tilton.

FIG. 11 is a graphical representation of the average damage severity by corn earworm feeding on a 1-10 scale, where 1 is no damage and 10 represents 100 of the plants and legumes are damaged.

FIG. 12 is a graphical representation of damage severity averaged over time for all treatments using the standardized area under disease progress curve formula.

FIG. 13 is a graphical representation of control of damage severity averaged over time for all treatments using the Abbot's formula.

FIG. 14 is a graphical representation of counts of marketable and unmarketable chickpea pods collected from the September 16th harvest.

FIG. 15 is a graphical representation of weight of marketable and unmarketable chickpeas collected from the September 16th harvest.

FIG. 16 is a graphical representation of average weight of a single chickpea based on the total yield weight divided by the yield count.

### DETAILED DESCRIPTION

According to some embodiments, a method for protecting a plant from an arthropod may include applying an amount of a repellant composition including diatomaceous earth to a plant. According to some embodiments, the repellent composition may render the plant unpalatable to the arthropod, resulting in death of the arthropod by starvation. According to some embodiments, the repellent composition causes the arthropod to avoid contact with the plant. For example, the method may result in protecting the plant without directly killing the arthropod. According to some embodiments, the repellant composition may cause the arthropod to avoid contact with the plant, but may also kill the arthropod. For example, the arthropod may avoid the plant, leading to starvation and/lack of reproduction of the arthropod.

According to some embodiments, a method for protecting a plant from an arthropod may include applying an amount of a repellant composition including diatomaceous earth to a plant. According to some embodiments, the arthropod may not include an exoskeleton, and the repellent composition may render the plant unpalatable to the arthropod, resulting in death of the arthropod by starvation. For example, the arthropod may be a soft-bodied organism. According to some embodiments, the soft-bodied organism may be a caterpillar. For example, caterpillar may be at least one of a caterpillar of moths, a caterpillar of earworm, a caterpillar of armyworm, a caterpillar of looper, and a caterpillar of leafminer.

Without wishing to be bound by theory, it is believed that the method including application of the repellant composition may effectively repel the arthropod before or after the arthropod eats a portion of the plant to which the repellent composition has been applied. For example, the arthropod may find the plant to which the repellent has been applied unpalatable and does not eat the plant, which may ultimately result in death by starvation without further significant damage to the plant. In other instances, the arthropod may eat a relatively small portion of the plant, thereby ingesting a portion of the plant and the repellent composition. As a result, the arthropod no longer finds the plant palatable, thus does not eat any more of the plant, and relatively quickly dies of starvation (i.e., relatively quickly dies as compared to an arthropod having an exoskeleton that dies as a result of loss of fluids resulting from damage to its exoskeleton, which may take, for example, two or more days).

This method, according to some embodiments, may be particularly effective at protecting plants from arthropods that do not have an exoskeleton. Traditional methods including the use of diatomaceous earth may not be effective at protecting plants from of such arthropods because, for example, they do not have an exoskeleton that is damaged by the diatomaceous earth. However, surprisingly, the methods according to some embodiments disclosed herein are effective at protecting plants from arthropods that do not have an exoskeleton, such as soft-bodied organisms, such as, for example, caterpillars and similar organisms, for example, caterpillars of moths, caterpillars of earworm, caterpillars of armyworm, caterpillars of looper, and caterpillars of leafminer.

Diatomaceous earth may be obtained from naturally occurring or “natural” diatomaceous earth (also called “DE” or “diatomite”), which is generally known as a sediment-enriched in biogenic silica (i.e., silica produced or brought about by living organisms) in the form of siliceous skeletons (frustules) of diatoms. Diatoms are a diverse array of microscopic, single-celled, golden-brown algae generally of the class Bacillariophyceae that possess an ornate siliceous skeleton of varied and intricate structures including two valves that, in the living diatom, fit together much like a pill box.

Diatomaceous earth may form from the remains of water-borne diatoms, and therefore, diatomaceous earth deposits may be found close to either current or former bodies of water. Those deposits are generally divided into two categories based on source: freshwater and saltwater. Freshwater diatomaceous earth is generally mined from dry lakebeds and may be characterized as having a low crystalline silica content and a high iron content. In contrast, saltwater diatomaceous earth is generally extracted from oceanic areas and may be characterized as having a high crystalline silica content and a low iron content.

According to some embodiments of the method, the method may be effective in protecting a plant including at least one of a corn plant, a citrus tree, a chickpea plant, a broccoli plant, a lettuce plant, a cabbage plant, and a strawberry plant. According to some embodiments of the method, the plant may include one of a cereal, an oilseed, a fruit tree, a berry plant, a vegetable, a pasture plant, a forage plant, and a fungi.

According to some embodiments of the method, the repellent composition may further include water. According to some embodiments, the repellent composition may further include at least one of soap and a composition including at least one of pyrethins and azadirachtin mixed in water. For example, the soap may be composition including fatty acids, such as, for example, potassium fatty acids, dissolved in water, such as, for example, soft water. For example, the fatty acids may be long-chain fatty acids having from, for example, 10 to 18 carbon atoms. The composition including at least one of pyrethins and azadirachtin mixed in water may be present in a product marketed under the tradename AZERA®. It is contemplated that the repellent composition may include other compositions.

According to some embodiments of the method, the repellent composition may be a slurry and may include from 0.1 lbs. to 1.5 lbs. of diatomaceous earth per gallon of repellent composition. For example, the repellent composition may be a slurry and may include from 0.2 lbs. to 1.3 lbs. of diatomaceous earth per gallon of repellent composition. For example, the repellent composition may include from 0.3 lbs. to 1.2 lbs. of diatomaceous earth per gallon of repellent composition, for example, from 0.5 lbs. to 1.0 lbs. of diatomaceous earth per gallon of repellent composition.

According to some embodiments, the repellent composition may include the diatomaceous earth, water, and one or more additional additives. For example, the repellent composition may include one or more of dispersants, wetting agents, antifoaming agents, thickeners, antifreeze, and anti-microbial agents.

According to some embodiments, the applying may include spraying the repellent composition onto one or more plants. For example, the repellent composition may be spayed onto the one or more plants may be sprayed at a pressure ranging from about 5 psi to 30 psi, such as, for example, from 10 psi to 25 psi. Other methods of applying the repellent composition are contemplated.

“Particle size,” as used herein, for example, in the context of particle size distribution (psd), is measured in terms of “equivalent spherical diameter” (esd). Sometimes referred to as the “d₅₀” value, median particle size and other particle size properties referred to in the present application may be measured in a well-known manner, for example, by sedimentation of the particle material in a fully-dispersed condition in an aqueous medium using a SEDIGRAPH 5100® machine, as supplied by Micromeritics Corporation. Such a machine may provide measurements and a plot of the cumulative percentage by weight of particles having a size (esd) less than the given esd value. The median particle size d₅₀ is the value that may be determined in this way of the particle esd at which there are 50% by weight of the particles that have an esd less than that d₅₀ value. Similarly, the small (or fine) particle size d₁₀ is the value at which there are 10% by weight of the particles that have an esd less than that d₁₀ value, and the top particle size do is the value at which there are 90% by weight of the particles that have an esd less than that d₉₀ value.

According to some embodiments, the diatomaceous earth may have a median particle size (d₅₀) of less than 15 microns, such as, for example, less than 12 microns, less than 10 microns, less than 9 microns, less than 8 microns, less than 7 microns, less than 6 microns, or less than 5 microns. According to some embodiments, the diatomaceous earth may have a d₉₀ of less than 40 microns, such as, for example, less than 35 microns, less than 30 microns, less than 25 microns, less than 20 microns, or less than 15 microns. According to some embodiments, the diatomaceous earth may have a d₁₀ of less than 5 microns, such as, for example, less than 4 microns, less than 3 microns, less than 2 microns, or less than 1 micron.

According to some embodiments, the diatomaceous earth may have an oil absorption of at least 1.0 grams of oil per gram of diatomaceous earth, such as, for example, at least 1.2 grams of oil per gram of diatomaceous earth, at least 1.3 grams of oil per gram of diatomaceous earth, at least 1.4 grams of oil per gram of diatomaceous earth, at least 1.5 grams of oil per gram of diatomaceous earth, at least 1.6 grams of oil per gram of diatomaceous earth, at least 1.7 grams of oil per gram of diatomaceous earth, or at least 1.8 grams of oil per gram of diatomaceous earth. According to some embodiments of the method, the diatomaceous earth may have an oil adsorption ranging from 105% by weight to 155% by weight. For example, the diatomaceous earth may have an oil adsorption ranging from 110% by weight to 150% by weight, from 115% by weight to 145% by weight, or from 120% by weight to 140% by weight.

According to some embodiments, the diatomaceous earth may be modified by silanization to render the surfaces more hydrophobic using the methods appropriate for silicate minerals (see e.g., U.S. Pat. No. 3,915,735 and U.S. Pat. No. 4,260,498). For example, the diatomaceous earth can be placed in a vessel, and a small quantity of dimethyldichlorosilane (i.e., SiCl₂(CH₃)₂) or hexadimethylsilazane (i.e., (CH₃)₃Si—NH—Si(CH₃)₃) added to the vessel. Reaction can be allowed to take place at the surface in the vapor phase over a 24 hr period, resulting in more hydrophobic products. Other hydrophobic coatings such as polydimethylsiloxane (PDMS) can also be used.

According to some other embodiments, the surface charge of the diatomaceous earth can also be modified to a more positively charged form using various coating agents such as amine containing molecules, multivalent metal cation, or amino acids.

According to some embodiments, the method may be effective in protecting a plant from an arthropod including at least one of a corn earworn, a psyllid, a thrip, an aphid, and a beetle. According to some embodiments of the method, the arthropod may include one of Insecta and Arachnida. For example, the Insecta may include one of Coleoptera, Diptera, Lepidopterea, Hemiptera, and Thysanoptera. For example, the Insecta may include one of a beetle, a potato beetle, a flea beetle, a larvae of a fly, a larvae of whitefly, and larvae of mosquito, a caterpillar of moths, a caterpillar of earworm, a caterpillar of armyworm, a caterpillar of looper, a caterpillar of leafminer, a lygus bug, an aphid, a psyllid, a scale insect, a mealybug, and a thrip. According to some embodiments, the Arachnida may include Acari. For example, the Acari may include one of a spider mite, a rust mite, and a gall mite.

According to some embodiments of the method, the arthropod may be a corn earworm, and the plant may be a chickpea plant. According to some embodiments, the arthropod may be a psyllid, and the plant may be a citrus tree. According to some embodiments, the arthropod may be one of a thrip and a beetle, and the plant may be a strawberry plant. According to some embodiments, the arthropod may be a thrip, and the plant may be a broccoli plant. According to some embodiments, the arthropod may be an aphid, and the plant may be a lettuce plant. According to some embodiments, the arthropod may be a beetle, and the plant may be a cabbage plant. According to some embodiments, the arthropod may be an earworm, and the plant may be one of a corn plant, a tomato plant, and a cotton plant. According to some embodiments, the arthropod may be a corn earworm, and the plant may be a chickpea plant.

According to some embodiments of the method, the diatomaceous earth may have a water adsorption ranging from 125% by weight to 175% by weight. For example, the diatomaceous earth may have a water adsorption ranging from 130% by weight to 170% by weight, from 135% by weight to 165% by weight, or from 140% by weight to 160% by weight.

According to some embodiments of the method, the diatomaceous earth may be a natural diatomaceous earth. For example, according to some embodiments, the diatomaceous earth may be a natural freshwater diatomaceous earth.

### Examples and Data

A trial was conducted to demonstrate the efficacy of CELITE 610 (a commercially available diatomaceous earth compound) for controlling corn earworm (Helicoverpa zea) on chickpeas grown in central California. CELITE 610® was applied three times at 35 and 70 lb/a, RADIANT® (10 fluid oz/a) a grower standard, and an untreated check.

Corn earworm counts were usually not significantly different between treatments for each instar. Control relative to the untreated (calculated using the Henderson-Tilton formula) for the first instar larvae showed significantly better control in the Radiant-treated plots, followed by the high rate (70 lb/a) of CELITE 610® in the 6 DA-C assessment. This followed for the 13 DA-C evaluations of second instars. Third and fourth instar control relative to the untreated was not statistically different between treated and untreated plots. However, for all instars combined, control relative to the untreated was significantly better on the lower rate of CELITE 610® than the higher.

Damage severity rated on a 1-10 scale, where 10 indicates severely blemished or injured leaf and pea shells, was significantly greater in the untreated plots. Average damage over time from the three evaluations showed the least amount of damage from plots treated with the 35 lb/a rate of CELITE 610®- and RADIANT®-treated plots.

Yield counts and total weights per plot were not significantly different between treatments, however, the average weight of single chickpeas were numerically greater in the RADIANT®-treated plants and lowest in the untreated check.

The trial consisted of four treatments applied August 16th (A), August 23rd (B) and August 30th (C), as follows:

1. Untreated;

2. Treatment with CELITE 610®-70 lb/a+0.25% v/v Spreader 90;

3. Treatment with CELITE 610-35 lb/a+0.25% v/v Spreader 90; and

4. Treatment with RADIANT®-10 fluid oz/a+0.25% v/v Spreader 90.

Chickpea seedlings were mechanically transplanted on April 30th into clay soil. Plots were 3.33 feet×30 feet on rows 3.33 feet apart. Plants were spaced 12 inches apart for a crop density of 13,081 plants/acre. Plots were replicated five times in a randomized complete block design.

Foliar sprays were applied using a boom with seven Disc-Core #23 nozzles using a backpack CO₂ sprayer. The boom was 52-inch wide, and treatments were applied at 70 GPA, 6 inches above the top of the plant.

Counts of larval instars one through four were carried out on ten plants per plot. Pest control was tabulated using the Henderson-Tilton equation on the average of summed insect counts. The Standardized Area Under the Disease Progress Curve was used to determine Insect-Day average (potential for daily damage caused by earworm) and percent disease control was calculated from that using Abbott's formula.

All calculations were carried out in ARM9 (Gylling Data Management). Statistics were analyzed using ANOVA mean comparison with LSD test and α=0.05. Bartlett's test for homogeneity of variances was used to determine the need for data transformations.

Table 1 below shows the average count of first instar corn earworm larvae on the chickpea at four rating intervals.

TABLE 1

| | | Aug. 12, | Aug. 29, | Sep. 5, | Sep. 12, |
|---|---|---|---|---|---|
| Trt | Treatment | 2014 | 2014 | 2014 | 2014 |
| No. | Name | PRECOUNT | 6 DA-B | 6 DA-C | 13 DA-C |
| 1 | Untreated | 0.3 a | 0.1 a | 0.3 a | 0.2 a |
| 2 | Celite 610 | 0.7 a | 0.0 a | 0.6 a | 0.2 a |
| | (70 lb/a) | | | | |
| | Spreader 90 | | | | |
| | (0.25% v/v) | | | | |
| 3 | Celite 610 | 1.0 a | 0.0 a | 0.1 a | 0.1 a |
| | (35 lb/a) | | | | |
| | Spreader 90 | | | | |
| | (0.25% v/v) | | | | |
| 4 | Radiant | 0.7 a | 0.0 a | 0.0 a | 0.0 a |
| | (10 fl oz/a) | | | | |
| | Spreader 90 | | | | |
| | (0.25% v/v) | | | | |

FIG. 1 is graphical representation of average count of first instar corn earworm larvae on the chickpea at four rating intervals.

Table 2 below shows first instar corn earworm larvae control using Henderson-Tilton, which takes into account pre-count adult populations per treatment. This percent control expresses the severity of insect pressure in treated plots, compared to plants in the untreated check controlling for pre-application populations. It was calculated using the Henderson-Tilton formula:

$$Corrected \% = ( 1 - \frac{n in Co before treatment \times n in T after treatment}{n in Co after treatment \times n in T after treatment} ) \times 100.$$

where: n=pest pressure, T=treated, Co=control.

TABLE 2

| | | Aug. 29, | Sep. 5, | Sep. 12, |
|---|---|---|---|---|
| Trt | Treatment | 2014 | 2014 | 2014 |
| No. | Name | 6 DA-B | 6 DA-C | 13 DA-C |
| 1 | Untreated | 0.00% a | 0.00% c | 0.00% b |
| 2 | Celite 610 | 20.00% a | 73.40% ab | 58.04% a |
| | (70 lb/a) | | | |
| | Spreader 90 | | | |
| | (0.25% v/v) | | | |
| 3 | Celite 610 | 39.40% a | 53.10% b | 74.07% a |
| | (35 lb/a) | | | |
| | Spreader 90 | | | |
| | (0.25% v/v) | | | |
| 4 | Radiant | 40.00% a | 100.00% a | 75.00% a |
| | (10 fl oz/a) | | | |
| | Spreader 90 | | | |
| | (0.25% v/v) | | | |

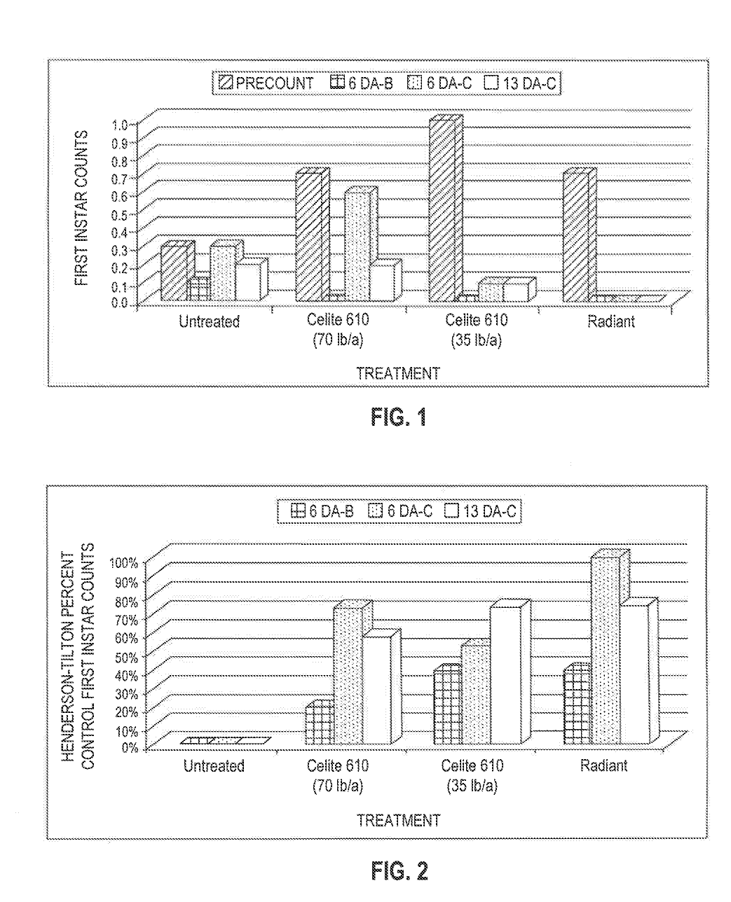

FIG. 2 is a graphical representation of first instar corn earworm larvae control using Henderson-Tilton.

Table 3 below shows average count of second instar corn earworm larvae on chickpeas at four rating intervals.

TABLE 3

| | | Aug. 12, | Aug. 29, | Sep. 5, | Sep. 12, |
|---|---|---|---|---|---|
| Trt | Treatment | 2014 | 2014 | 2014 | 2014 |
| No. | Name | PRECOUNT | 6 DA-B | 6 DA-C | 13 DA-C |
| 1 | Untreated | 0.4 a | 0.1 a | 0.2 a | 0.3 a |
| 2 | Celite 610 | 0.3 a | 0.0 a | 0.1 a | 0.3 a |
| | (70 lb/a) | | | | |
| | Spreader 90 | | | | |
| | (0.25% v/v) | | | | |
| 3 | Celite 610 | 0.2 a | 0.0 a | 0.0 a | 0.1 a |
| | (35 lb/a) | | | | |
| | Spreader 90 | | | | |
| | (0.25% v/v) | | | | |
| 4 | Radiant | 0.3 a | 0.0 a | 0.0 a | 0.1 a |
| | (10 fl oz/a) | | | | |
| | Spreader 90 | | | | |
| | (0.25% v/v) | | | | |

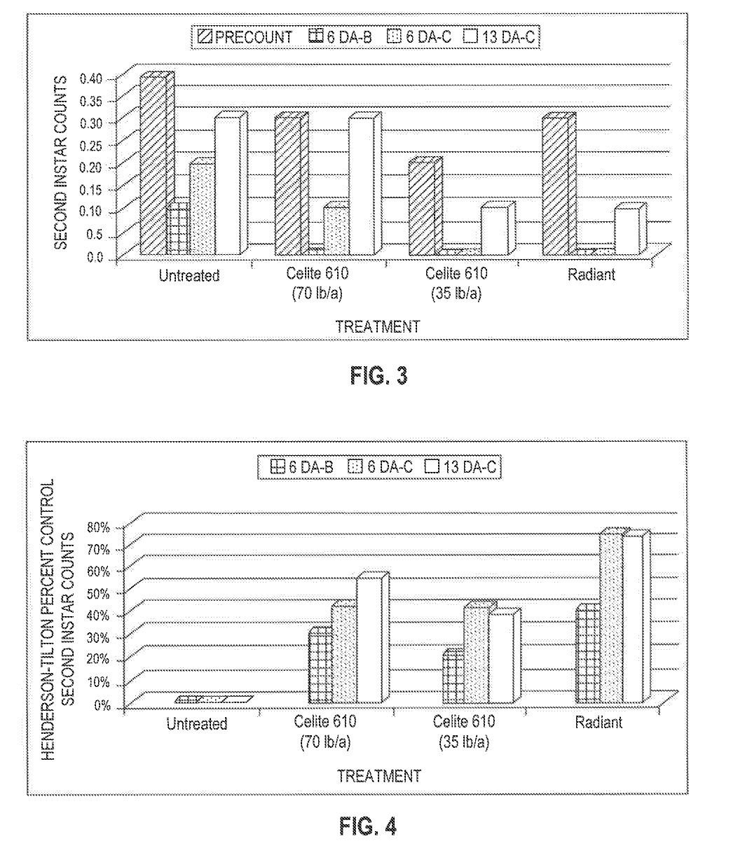

FIG. 3 is a graphical representation of average count of second instar larvae corn earworm on the chickpea at four rating intervals.

Table 4 below shows second instar corn earworm larvae control using Henderson-Tilton.

TABLE 4

| | | Aug. 29, | Sep. 5, | Sep. 12, |
|---|---|---|---|---|
| Trt | Treatment | 2014 | 2014 | 2014 |
| No. | Name | 6 DA-B | 6 DA-C | 13 DA-C |
| 1 | Untreated | 0.0% a | 0.0% a | 0.0% b |
| 2 | Celite 610 | 30.0% a | 43.3% a | 55.4% a |
| | (70 lb/a) | | | |
| | Spreader 90 | | | |
| | (0.25% v/v) | | | |
| 3 | Celite 610 | 20.0% a | 41.7% a | 38.9% ab |
| | (35 lb/a) | | | |
| | Spreader 90 | | | |
| | (0.25% v/v) | | | |
| 4 | Radiant | 40.0% a | 75.0% a | 74.0% a |
| | (10 fl oz/a) | | | |
| | Spreader 90 | | | |
| | (0.25% v/v) | | | |

FIG. 4 is a graphical representation of second instar corn earworm larvae control using Henderson-Tilton.

Table 5 below shows average count of third instar corn earworm larvae on chickpeas at four rating intervals.

TABLE 5

| | | Aug. 12, | Aug. 29, | Sep. 5, | Sep. 12, |
|---|---|---|---|---|---|
| Trt | Treatment | 2014 | 2014 | 2014 | 2014 |
| No. | Name | PRECOUNT | 6 DA-B | 6 DA-C | 13 DA-C |
| 1 | Untreated | 0.2 a | 0.1 a | 0.1 a | 0.5 a |
| 2 | Celite 610 | 0.2 a | 0.0 b | 0.0 b | 0.2 ab |
| | (70 lb/a) | | | | |
| | Spreader 90 | | | | |
| | (0.25% v/v) | | | | |
| 3 | Celite 610 | 0.1 a | 0.0 b | 0.0 b | 0.1 b |
| | (35 lb/a) | | | | |
| | Spreader 90 | | | | |
| | (0.25% v/v) | | | | |
| 4 | Radiant | 0.1 a | 0.0 b | 0.0 b | 0.0 b |
| | (10 fl oz/a) | | | | |
| | Spreader 90 | | | | |
| | (0.25% v/v) | | | | |

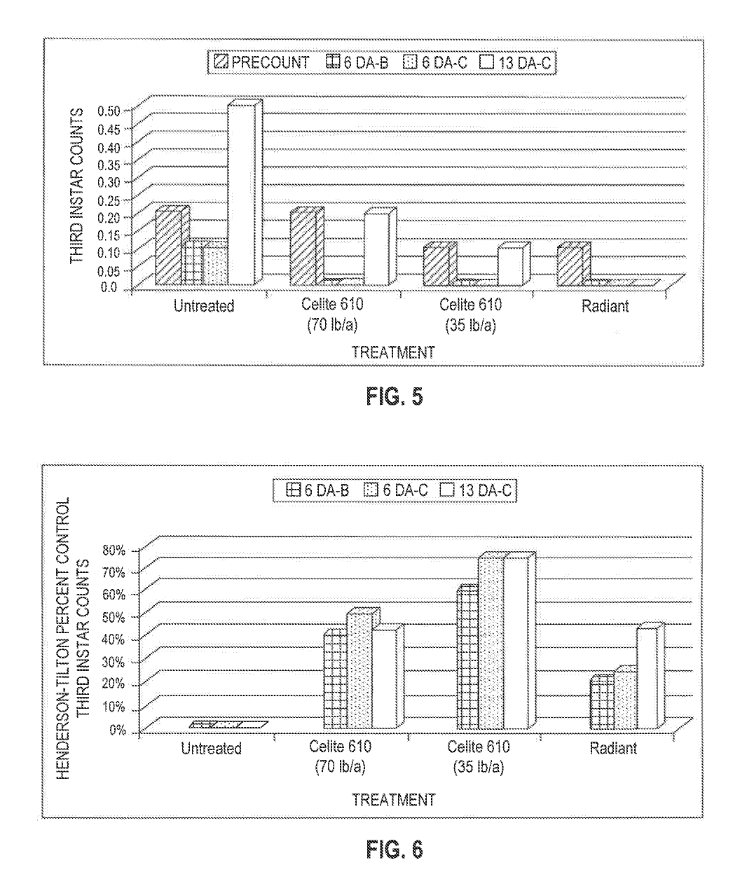

FIG. 5 is a graphical representation of average count of third instar larvae corn earworms on the chickpea at four rating intervals.

Table 6 below shows third instar corn earworm larvae control using Henderson-Tilton.

TABLE 6

| | | Aug. 29, | Sep. 5, | Sep. 12, |
|---|---|---|---|---|
| Trt | Treatment | 2014 | 2014 | 2014 |
| No. | Name | 6 DA-B | 6 DA-C | 13 DA-C |
| 1 | Untreated | 0.0% a | 0.0% a | 0.0% a |
| 2 | Celite 610 | 40.0% a | 50.0% a | 43.8% a |
| | (70 lb/a) | | | |
| | Spreader 90 | | | |
| | (0.25% v/v) | | | |
| 3 | Celite 610 | 60.0% a | 75.0% a | 75.0% a |
| | (35 lb/a) | | | |
| | Spreader 90 | | | |
| | (0.25% v/v) | | | |
| 4 | Radiant | 20.0% a | 25.0% a | 43.8% a |
| | (10 fl oz/a) | | | |
| | Spreader 90 | | | |
| | (0.25% v/v) | | | |

FIG. 6 is a graphical representation of third instar corn earworm larvae control using Henderson-Tilton.

Table 7 below shows average count of fourth instar corn earworm larvae on chickpeas at four rating intervals.

TABLE 7

| | | Aug. 12, | Aug. 29, | Sep. 5, | Sep. 12, |
|---|---|---|---|---|---|
| Trt | Treatment | 2014 | 2014 | 2014 | 2014 |
| No. | Name | PRECOUNT | 6 DA-B | 6 DA-C | 13 DA-C |
| 1 | Untreated | 0.2 a | 0.0 a | 0.0 a | 0.3 a |
| 2 | Celite 610 | 0.1 a | 0.0 a | 0.0 a | 0.1 ab |
| | (70 lb/a) | | | | |
| | Spreader 90 | | | | |
| | (0.25% v/v) | | | | |
| 3 | Celite 610 | 0.1 a | 0.0 a | 0.0 a | 0.1 ab |
| | (35 lb/a) | | | | |
| | Spreader 90 | | | | |
| | (0.25% v/v) | | | | |
| 4 | Radiant | 0.1 a | 0.0 a | 0.0 a | 0.0 b |
| | (10 fl oz/a) | | | | |
| | Spreader 90 | | | | |
| | (0.25% v/v) | | | | |

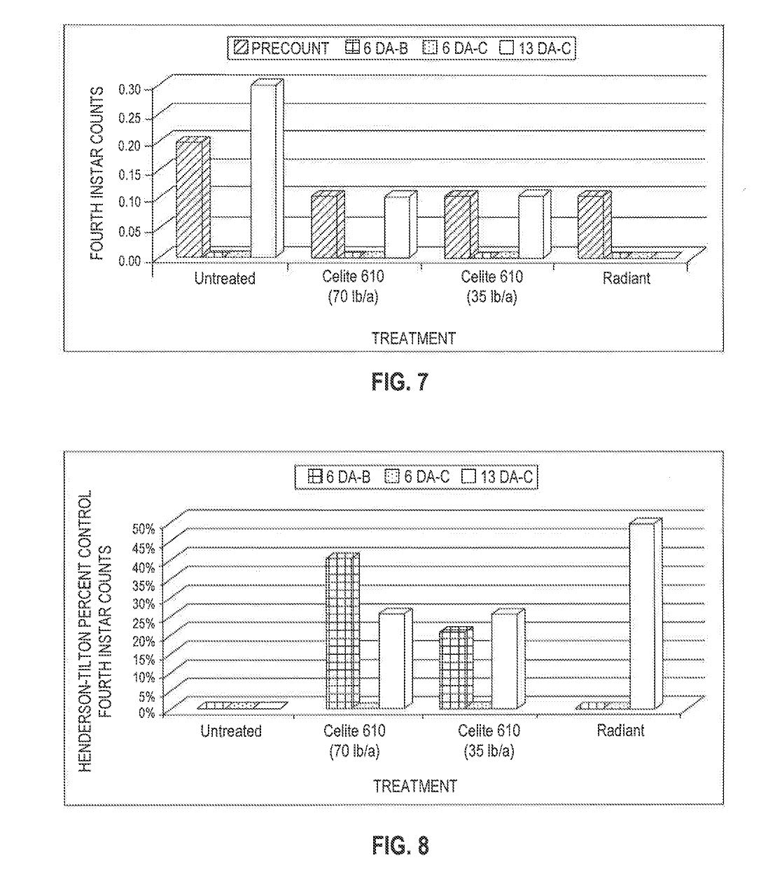

FIG. 7 is a graphical representation of average count of fourth instar larvae corn earworms on the chickpea at four rating intervals.

Table 8 below shows fourth instar corn earworm larvae control using Henderson-Tilton.

TABLE 8

| | | Aug. 29, | Sep. 5, | Sep. 12, |
|---|---|---|---|---|
| Trt | Treatment | 2014 | 2014 | 2014 |
| No. | Name | 6 DA-B | 6 DA-C | 13 DA-C |
| 1 | Untreated | 0.0% a | 0.0% a | 0.0% a |
| 2 | Celite 610 | 40.0% a | 0.0% a | 25.0% a |
| | (70 lb/a) | | | |
| | Spreader 90 | | | |
| | (0.25% v/v) | | | |
| 3 | Celite 6.10 | 20.0% a | 0.0% a | 25.0% a |
| | (35 lb/a) | | | |
| | Spreader 90 | | | |
| | (0.25% v/v) | | | |
| 4 | Radiant | 0.0% a | 0.0% a | 50.0% a |
| | (10 fl oz/a) | | | |
| | Spreader 90 | | | |
| | (0.25% v/v) | | | |

FIG. 8 is a graphical representation of fourth instar corn earworm larvae control using Henderson-Tilton.

Table 9 below shows an average count of all instars of corn earworm larvae on chickpeas at four rating intervals.

TABLE 9

| | | Aug. 12, | Aug. 29, | Sep. 5, | Sep. 12, |
|---|---|---|---|---|---|
| Trt | Treatment | 2014 | 2014 | 2014 | 2014 |
| No. | Name | PRECOUNT | 6 DA-B | 6 DA-C | 13 DA-C |
| 1 | Untreated | 1.0 a | 0.3 a | 0.6 a | 1.3 a |
| 2 | Celite 610 | 1.3 a | 0.1 b | 0.8 a | 0.8 a |
| | (70 lb/a) | | | | |
| | Spreader 90 | | | | |
| | (0.25% v/v) | | | | |
| 3 | Celite 610 | 1.4 a | 0.0 b | 0.2 a | 0.3 a |
| | (35 lb/a) | | | | |
| | Spreader 90 | | | | |
| | (0.25% v/v) | | | | |
| 4 | Radiant | 1.2 a | 0.0 b | 0.0 a | 0.2 a |
| | (10 fl oz/a) | | | | |
| | Spreader 90 | | | | |
| | (0.25% v/v) | | | | |

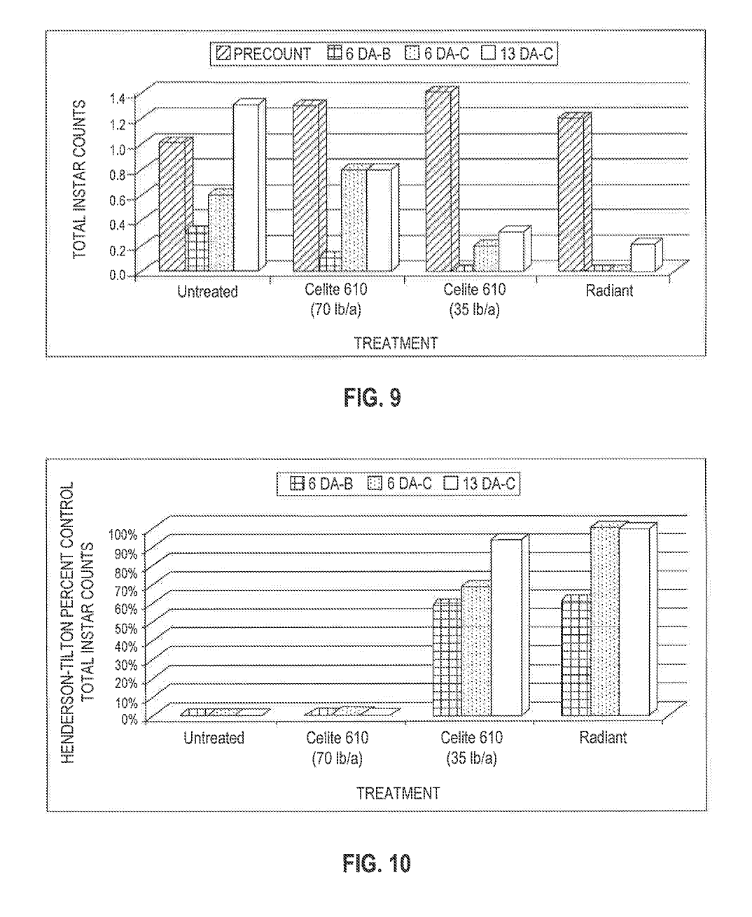

FIG. 9 is a graphical representation showing average count of all instars of corn earworm larvae on chickpeas at four rating intervals.

Table 10 below shows all instars of corn earworm larvae control using Henderson-Tilton.

TABLE 10

| | | Aug. 29, | Sep. 5, | Sep. 12, |
|---|---|---|---|---|
| Trt | Treatment | 2014 | 2014 | 2014 |
| No. | Name | 6 DA-B | 6 DA-C | 13 DA-C |
| 1 | Untreated | 0.0% b | 0.0% b | 0.0% c |
| 2 | Celite 610 | 0.4% ab | 0.7% a | 0.6% b |
| | (70 lb/a) | | | |
| | Spreader 90 | | | |
| | (0.25% v/v) | | | |
| 3 | Celite 610 | 58.2% a | 67.9% a | 92.6% ab |
| | (35 lb/a) | | | |
| | Spreader 90 | | | |
| | (0.25% v/v) | | | |
| 4 | Radiant | 60.0% a | 100.0% a | 99.0% a |
| | (10 fl oz/a) | | | |
| | Spreader 90 | | | |
| | (0.25% v/v) | | | |

FIG. 10 is a graphical representation of all instars of corn earworm larvae control using Henderson-Tilton.

Table 11 below shows average damage severity by corn earworm feeding on a 1-10 scale, where 1 is no damage and 10 represents 100 of the plant and legume are damaged.

TABLE 11

| | | Aug. 23, | Aug. 29, | Sep. 5, | Sep. 12, |
|---|---|---|---|---|---|
| Trt | Treatment | 2014 | 2014 | 2014 | 2014 |
| No. | Name | 7 DA-A | 6 DA-B | 6 DA-C | 13 DA-C |
| 1 | Untreated | 1.0 a | 0.5 a | 1.0 a | 2.0 a |
| 2 | Celite 610 | 0.8 a | 0.2 b | 0.3 b | 1.2 ab |
| | (70 lb/a) | | | | |
| | Spreader 90 | | | | |
| | (0.25% v/v) | | | | |
| 3 | Celite 610 | 0.9 a | 0.1 b | 0.2 b | 0.9 b |
| | (35 lb/a) | | | | |
| | Spreader 90 | | | | |
| | (0.25% v/v) | | | | |
| 4 | Radiant | 0.9 a | 0.1 b | 0.1 b | 0.3 b |
| | (10 fl oz/a) | | | | |
| | Spreader 90 | | | | |
| | (0.25% v/v) | | | | |

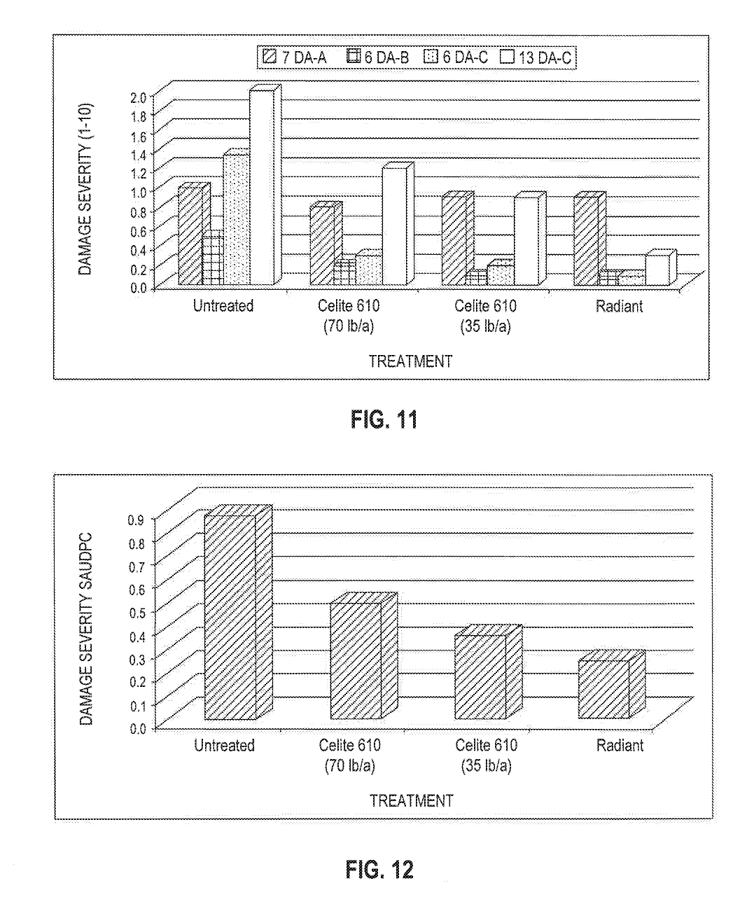

FIG. 11 is a graphical representation of the average damage severity by corn earworm feeding on a 1-10 scale, where 1 is no damage and 10 represents 100 of the plant and legume are damaged.

Table 12 below shows damage severity averaged over time for all treatments using the standardized area under disease progress curve formula. The average damage over time is a function of the area under the disease progress curve. AUDPC calculates the average insect damage ratings between each pair of adjacent time points. It is calculated by determining the average distance in rise of intensity for each evaluation date and adding them together by treatment according to the following formula:

$${\sum }_{t = 1}^{Ni - 1} \frac{{y}_{i} - {y}_{i - 1}}{2} ( {t}_{i} - {t}_{i - 1} )$$

where y=severity, t=time, N=average insect populations between two adjacent time points. Standardization of AUDPC (SAUDPC) is calculated with equation:

$$SAUDPC = 1 - \frac{AUDPC}{{AUDPC}_{ma x}}$$

where AUDPCₘₐₓ is the maximum possible area obtained when insect damage is greatest. SAUDPC values are an average of the pest damage severity over time.

TABLE 12

| Trt | Treatment | SEVERITY |
|---|---|---|
| No. | Name | SAUDPC |
| 1 | Untreated | 0.868 a |
| 2 | Celite 610 | 0.493 ab |
| | (70 lb/a) | |
| | Spreader 90 | |
| | (0.25% v/v) | |
| 3 | Celite 610 | 0.352 b |
| | (35 lb/a) | |
| | Spreader 90 | |
| | (0.25% v/v) | |
| 4 | Radiant | 0.245 b |
| | (10 fl oz/a) | |
| | Spreader 90 | |
| | (0.25% v/v) | |

FIG. 12 is a graphical representation of damage severity averaged over time for all treatments using the standardized area under disease progress curve formula.

Table 13 shows control of damage severity averaged over time for all treatments, using the Abbot's formula. This percent control expresses the severity of Insect damage in treated plots, compared to plants in the untreated check. It was calculated using the Abbott formula:

$$Corrected \% = ( 1 - \frac{n in T after treatment}{n in T after treatment} ) \times 100$$

Where: n=pest pressure, T=treated, Co=control.

TABLE 13

| Trt | Treatment | SEVERITY |
|---|---|---|
| No. | Name | % CONTROL |
| 1 | Untreated | 0.00% b |
| 2 | Celite 610 | 45.59% a |
| | (70 lb/a) | |
| | Spreader 90 | |
| | (0.25% v/v) | |
| 3 | Celite 610 | 45.22% a |
| | (35 lb/a) | |
| | Spreader 90 | |
| | (0.25% v/v) | |
| 4 | Radiant | 62.25% a |
| | (10 fl oz/a) | |
| | Spreader 90 | |
| | (0.25% v/v) | |

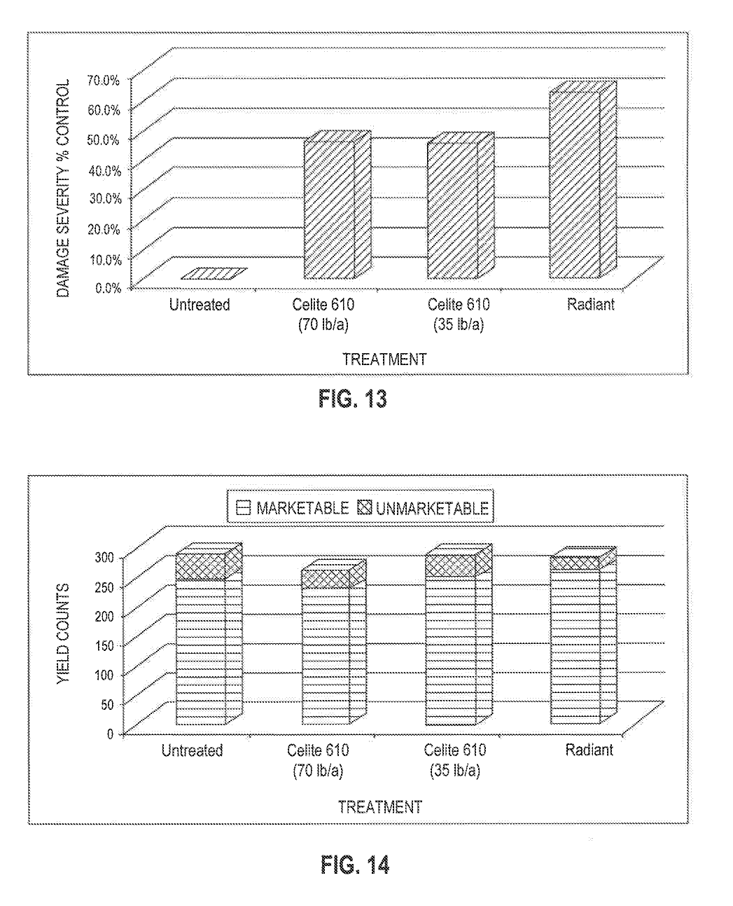

FIG. 13 is a graphical representation of control of damage severity averaged over time for all treatments using the Abbot's formula.

Table 14 below shows counts of marketable and unmarketable chickpea pods collected from the September 16th harvest.

TABLE 14

| Trt | Treatment | | |
|---|---|---|---|
| No. | Name | MARKETABLE | UNMARKETABLE |
| 1 | Untreated | 249.8 a | 38.6 a |
| 2 | Celite 610 | 233.2 a | 28.0 a |
| | (70 lb/a) | | |
| | Spreader 90 | | |
| | (0.25% v/v) | | |
| 3 | Celite 610 | 253.0 a | 33.6 a |
| | (35 lb/a) | | |
| | Spreader 90 | | |
| | (0.25% v/v) | | |
| 4 | Radiant | 265.0 a | 17.0 a |
| | (10 fl oz/a) | | |
| | Spreader 90 | | |
| | (0.25% v/v) | | |

FIG. 14 is a graphical representation of counts of marketable and unmarketable chickpea pods collected from the September 16th harvest.

Table 15 below shows weight of marketable and unmarketable chickpeas collected from the September 16th harvest.

TABLE 15

| Trt | Treatment | Sep. 16, 2014 |
|---|---|---|
| No. | Name | YIELD WT. (G) |
| 1 | Untreated | 179.4 a |
| 2 | Celite 610 | 171.8 a |
| | (70 lb/a) | |
| | Spreader 90 | |
| | (0.25% v/v) | |
| 3 | Celite 610 | 182.4 a |
| | (35 lb/a) | |
| | Spreader 90 | |
| | (0.25% v/v) | |
| 4 | Radiant 10 | 208.4 a |
| | (fl oz/a) | |
| | Spreader 90 | |
| | (0.25% v/v) | |

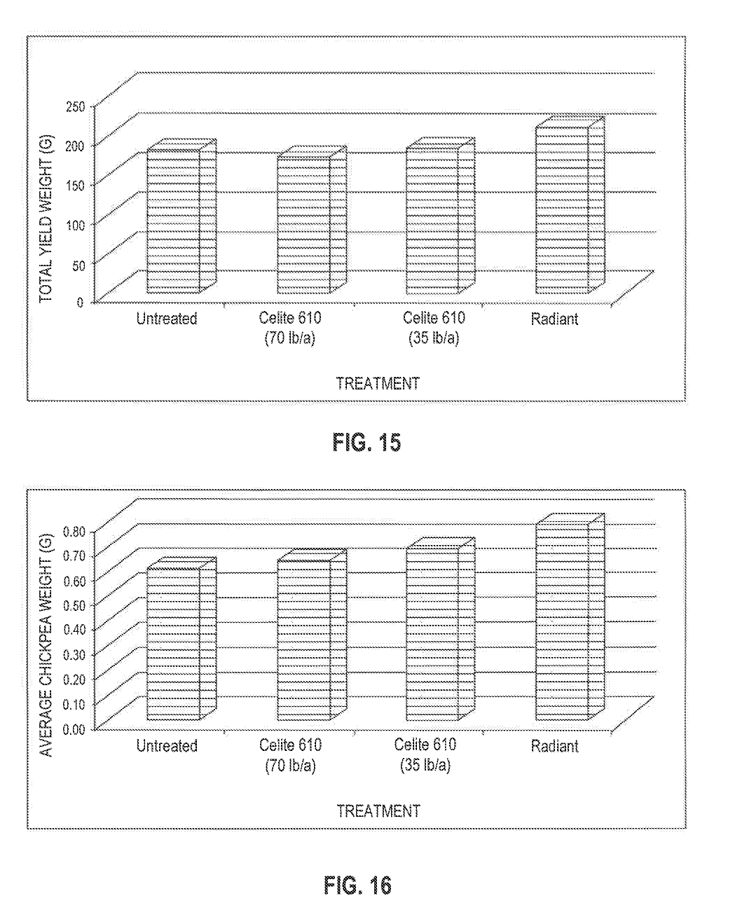

FIG. 15 is a graphical representation of weight of marketable and unmarketable chickpeas collected from the September 16th harvest.

Table 16 below shows average weight of a single chickpea in grams based on the total yield weight divided by the yield count.

TABLE 16

| Trt | Treatment | Sep. 16, 2014 |
|---|---|---|
| No. | Name | WT/CHICKPEA |
| 1 | Untreated | 0.603 a |
| 2 | Celite 610 | 0.636 a |
| | (70 lb/a) | |
| | Spreader 90 | |
| | (0.25% v/v) | |
| 3 | Celite 610 | 0.689 a |
| | (35 lb/a) | |
| | Spreader 90 | |
| | (0.25% v/v) | |
| 4 | Radiant | 0.798 a |
| | (10 fl oz/a) | |
| | Spreader 90 | |
| | (0.25% v/v) | |

FIG. 16 is a graphical representation of average weight of a single chickpea based on the total yield weight divided by the yield count.

The testing shows that there were no significant differences in the first instar corn earworm counts between treatments. The testing also shows that RADIANT®-treated chickpeas had significantly better first though second instar earworm control than the 70 lb/a rate of CELITE 610®, but the CELITE 610® did show a positive dose response with this age of larvae. The testing also shows that damage severity was greatest in the untreated plots. The average damage over time was significantly greater in the untreated plots and lowest in the plots treated with 35 lb/a rate of CELITE 610®- and RADIANT®-treated plots, suggesting CELITE 610® is reducing feeding. There was no significant difference in counts of pods, and total weights of peas were not significantly different amongst treatments, but marketable pea weights were numerically greater from the RADIANT®-treated plots.

Other embodiments will be apparent to those skilled in the art from consideration of the specification and practice of the embodiments disclosed herein. It is intended that the specification and examples be considered as exemplary only.

1. A method for protecting a plant from an arthropod, the method comprising:
applying an amount of a repellant composition comprising diatomaceous earth to a plant,
wherein the repellent composition renders the plant unpalatable to the arthropod, resulting in death of the arthropod by starvation.

2. The method of claim 1, wherein the repellent composition does not directly cause mortality of the arthropod.

3. The method of claim 1, wherein the repellent composition causes the arthropod to avoid contact with the plant.

4. The method of claim 1, wherein the plant is one of a corn plant, a citrus tree, a chickpea plant, a broccoli plant, a lettuce plant, a cabbage plant, and a strawberry plant.

5. The method of claim 1, wherein the arthropod does not include an exoskeleton.

6. The method of claim 1, wherein the arthropod is a soft-bodied organism.

7. The method of claim 6, wherein the soft-bodied organism comprises a caterpillar.

8. The method of claim 7, wherein the caterpillar comprises at least one of a caterpillar of moths, a caterpillar of earworm, a caterpillar of armyworm, a caterpillar of looper, and a caterpillar of leafminer.

9. The method of claim 1, wherein the arthropod is one of a corn earworm, a psyllid, a thrip, an aphid, and a beetle.

10. The method of claim 1, wherein the repellent composition further comprises at least one of soap and a composition including at least one of pyrethins and azadirachtin mixed in water.

11. The method of claim 1, wherein the repellent composition is a slurry and comprises from 0.1 lbs. to 1.5 lbs. of diatomaceous earth per gallon of repellent composition.

12-19. (canceled)

20. The method of claim 1, wherein the plant comprises one of a cereal, an oilseed, a fruit tree, a berry plant, a vegetable, a pasture plant, a forage plant, and a fungi.

21. The method of claim 1, wherein the arthropod is a corn earworm, and the plant is a chickpea plant.

22. The method of claim 1, wherein the arthropod is a psyllid, and the plant is a citrus tree.

23. The method of claim 1, wherein the arthropod is one of a thrip and a beetle, and the plant is a strawberry plant.

24. The method of claim 1, wherein the arthropod is a thrip, and the plant is a broccoli plant.

25. The method of claim 1, wherein the arthropod is an aphid, and the plant is a lettuce plant.

26. The method of claim 1, wherein the arthropod is a beetle, and the plant is a cabbage plant.

27. The method of claim 1, wherein the arthropod is an earworm, and the plant is one of a corn plant, a tomato plant, and a cotton plant.

28. The method of claim 1, wherein the arthropod is a corn earworm, and the plant is a chickpea plant.

29. The method claim 1, wherein the diatomaceous earth has a water adsorption ranging from 125% by weight to 175% by weight.

30-32. (canceled)

33. The method of claim 1, wherein the diatomaceous earth has an oil adsorption ranging from 105% by weight to 155% by weight.

34-38. (canceled)

39. The method of claim 1, wherein the mineral composition is modified by silanization.

40. (canceled)

41. A method for protecting a plant from an arthropod, the method comprising:
applying an amount of a repellant composition comprising diatomaceous earth to a plant,
wherein the arthropod does not include an exoskeleton, and
wherein the repellent composition renders the plant unpalatable to the arthropod, resulting in death of the arthropod by starvation.

42-44. (canceled)
